(19) United States
(12) Patent Application Publication
(10) Pub. No.: US 2003/0113669 A1
(43) Pub. Date: Jun. 19, 2003

(54) Method of fabricating passive device on printed circuit board

(76) Inventors: Jao-Chin Cheng, Hsinchu City (TW); Chia-Pin Lin, Sanchung (TW); Ting-Liang Fang, Taoyuan Hsien (TW); Chang-Yun Hung, Yangmei (TW)

Correspondence Address: J.C. Patents, Inc., 4 Venture, Suite 250, Irvine, CA, 92618, US

(21) Appl. No.: 10/033,755

(22) Filed: Dec. 19, 2001

(51) Int. Cl. G03C 5/00

(52) U.S. Cl. 430/311; 430/313; 430/315

(57) ABSTRACT

A method of fabricating a passive device on a printed circuit board. A first substrate and a second substrate are provided. Each of the first and the second substrates has an insulation core layer and a conductive layer on the insulation core layer. A dielectric layer is coated on the first substrate to cover a surface of the conductive layer thereon as an internal dielectric layer. The second substrate is laminated onto the internal dielectric layer, so that the conductive layers of the first and the second substrates are adjacent to the internal dielectric layer.

### BACKGROUND OF THE INVENTION

1. Field of the Invention

The invention relates in general to a method of fabricating a passive device on a printed circuit board, and more particularly, to a method of fabricating a passive device using a coating process.

2. Description of the Related Art

A printed circuit board often comprises a great amount of electronic devices, including active and passive devices. By the combination of the active and passive devices, various functions may be obtained. For example, the printed circuit board may be fabricated as a display card, a sound card, a network or other function card. The passive devices include resistors, capacitors and inductors. In addition to being mounted on the surface, some passive devices may also be formed in the inner layer of the printed circuit board during the fabrication process thereof.

However, forming passive devices by the current printed circuit board fabrication process is still problematic.

In the conventional printed circuit board fabrication process, two printed circuit boards are laminated with a plate of dielectric material purchased from the supplier. The conductive lines on the two printed circuit boards are thus connected to the plate of dielectric material to form a capacitor. Since the plate of dielectric material is directly purchased from the supplier, the thickness thereof cannot be adjusted. Consequently, fine adjustment of capacitance cannot be achieved. Capacitance beyond the material specification cannot be obtained either. Further, the structure of the dielectric material may cause handling difficulty, and the thickness of the dielectric layer is restricted.

Therefore, the design flexibility of the capacitor is restricted by the structure of the supplied dielectric material. If a particular capacitance is required, a special plate of dielectric material has to be ordered in advance. Consequently, the fabrication cost is raised.

In addition, the conventional printed circuit board fabrication process uses a bridging method to form a resistor. FIGS. 1 to 3 show the conventional method for forming a resistor on a printed circuit board.

In FIG. 1, a first metal line 106 is formed on a substrate 100. In FIG. 2, a second metal line 103 is superposed on the first metal line 106. In FIG. 3, a part of the second metal line 103 is etched, so that the resultant second metal line 103b is in an open state.

In the conventional printed circuit board fabrication process, the first and second metals 106 and 103 are formed on different planes with an overlapped portion, so that it is difficult to calculate the effective area and length. The resistance is thus difficult to control. Consequently, the problem of unstable resistance occurs.

Thus, the resistor formed by the conventional printed circuit board fabrication process has the problems of unstable and uncontrollable resistance.

Accordingly, the conventional method for fabricating a passive device of a printed circuit board has the drawbacks of reducing the design flexibility, increasing the thickness of the printed circuit board and difficulty in calculating the resistance.

### SUMMARY OF THE INVENTION

The present invention provides a method of fabricating a passive device of a printed circuit board, by which various capacitance values can be obtained, so that the design flexibility is increased.

The method of fabricating a passive device of a printed circuit board provided by the invention further allows forming a resistor on the printed circuit board without increasing the thickness thereof.

The method of fabricating a passive device of a printed circuit board provided by the invention further allows for calculating the resistor value precisely.

In the method of fabricating a passive device of a printed circuit board as mentioned above, a first substrate and a second substrate are provided. Each of the first and second substrates has an insulation core layer and a conductive layer on the insulation core layer. A dielectric layer is coated over the first substrate to cover a surface of the conductive layer thereon, and to form an internal dielectric layer. The second substrate is laminated to the internal dielectric layer with the conductive layer facing thereto, such that the conductive layers of the first and second substrates are adjacent to the internal dielectric layer on the opposing surfaces thereof.

In another embodiment of the invention, a substrate having an insulation core layer and a first conductive line on the insulation core layer is provided. An insulation layer is formed to cover the insulation core layer with the surface thereof level to that of the first conductive line. A part of the first conductive line is removed to form an opening that results in making the first conductive line an open circuit. A conductive material is coated to fill the opening, so as to form a second conductive line. The second conductive line is conducted to the first conductive line, while the conductive material for forming the second conductive line has a conductivity different from that of the first conductive line.

In the present invention, the internal dielectric layer is formed by a coating process, so that the thickness is adjustable. That is, the capacitance of the passive device is easily adjustable. Further, a capacitance with an internal dielectric layer thinner than that of the conventional plate of dielectric material is formed.

The coating process allows formation of the second conductive line between the open first conductive line, so that a passive device (resistor) is formed without increasing the thickness of the substrate.

Further, the coating process allows the first and second conductive lines to be formed on the same layer, so that the resistance can be precisely calculated.

Both the foregoing general description and the following detailed description are exemplary and explanatory only and are not restrictive of the invention, as claimed.

### BRIEF DESCRIPTION OF THE DRAWINGS

FIGS. 1 to 3 show a conventional fabricating process for forming a resistor of a printed circuit board;

FIGS. 4-14 show a first embodiment of the invention for forming a passive device of a printed circuit board;

FIGS. 15-22 show another embodiment of the invention for forming another passive device of a printed circuit board; and

FIG. 23 shows a top view of FIG. 22.

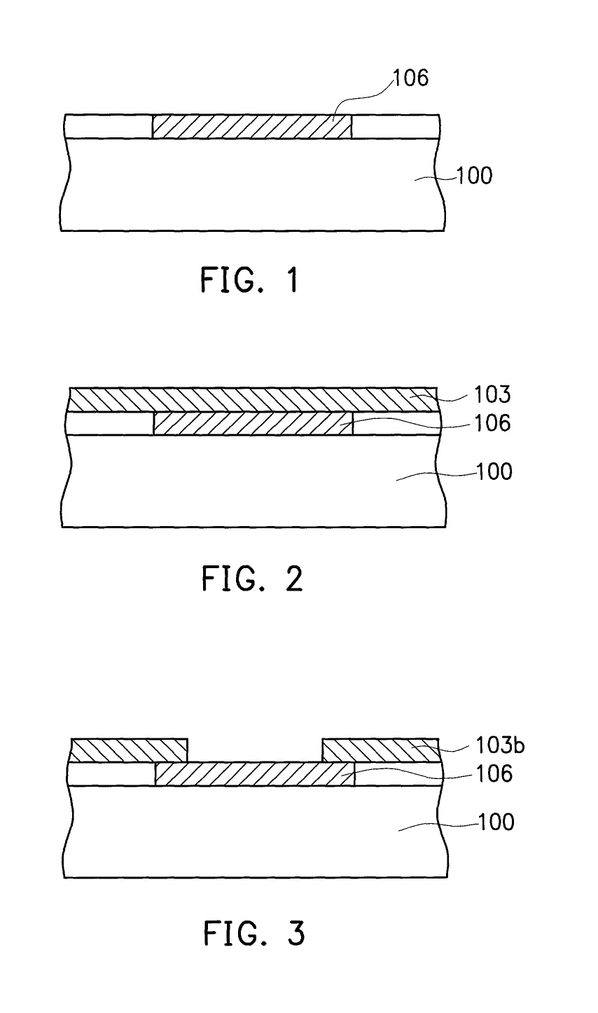

### DESCRIPTION OF THE PREFERRED EMBODIMENTS

First Embodiment

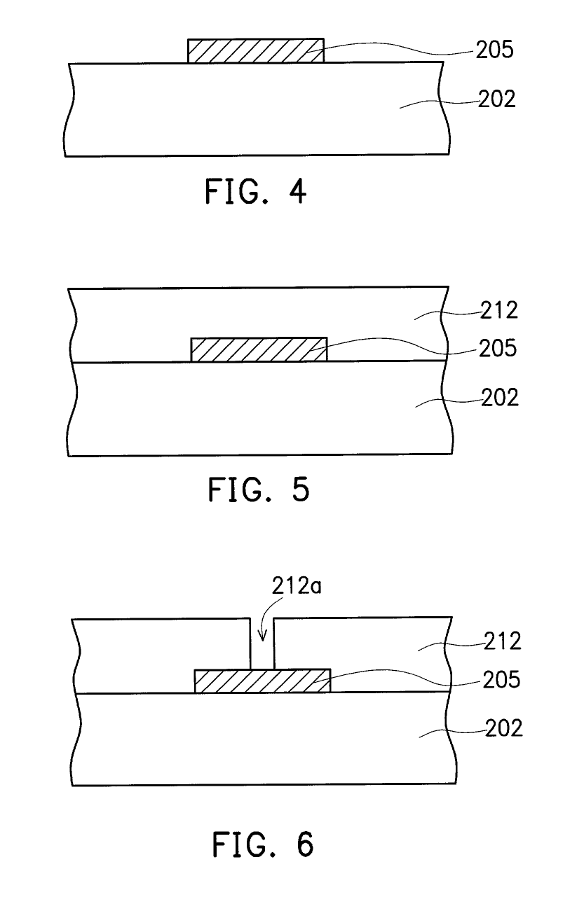

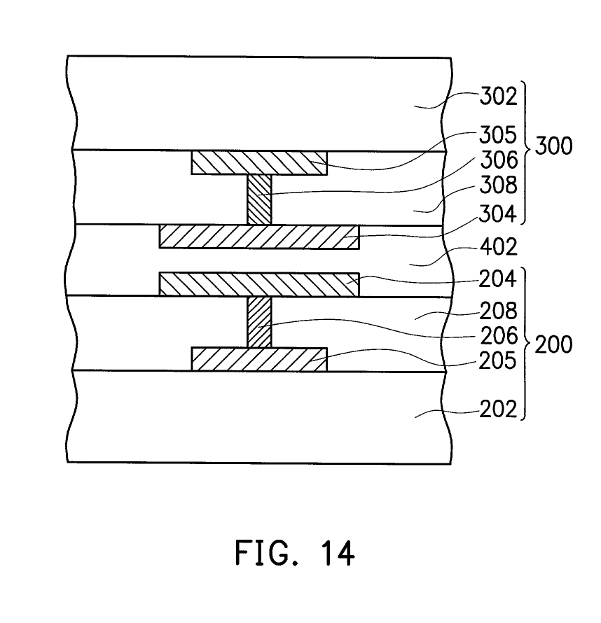

Referring to FIGS. 4-14, a first embodiment of the invention for forming a passive device of a printed circuit board is shown.

Referring initially to FIGS. 11-14, a first substrate 200 comprising at least a first insulation core layer 202 and a first conductive layer 204 is provided in FIG. 11. The first conductive layer 204 is located over the first insulation core layer 202. The method of forming the conductive line 205, interconnect 206, and insulation layer 208, in the first substrate is described later. In FIG. 12, a dielectric material 402a is coated over the first substrate 200 to form an internal dielectric layer 402 on the first layer 204. The method for coating the dielectric material 402a includes spray coating, spin coating, screen printing and cylinder press.

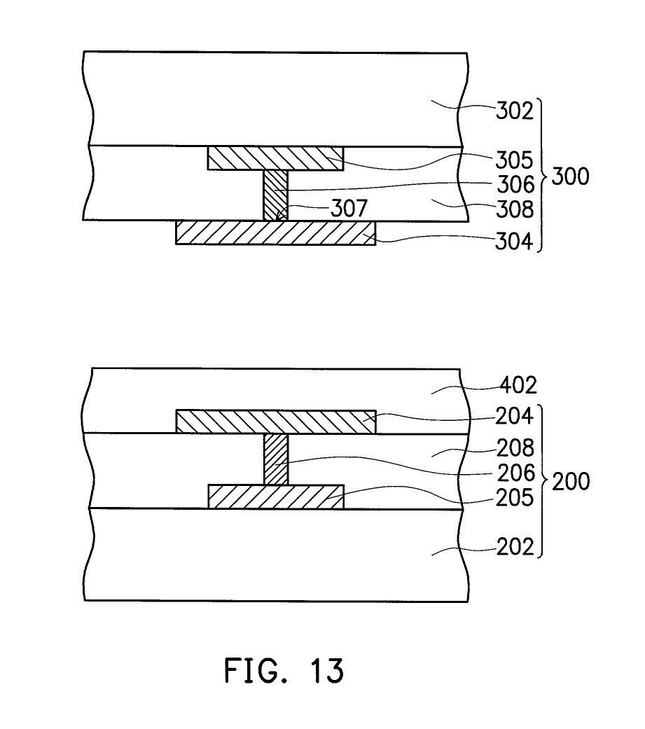

Referring to FIG. 13, a second substrate 300 is provided. The second substrate comprises at least a second insulation core layer 302 and a second conductive line 304 located over the second insulation core layer 302. The method of forming the conductive line 305, interconnect 306 and insulation layer 308 is the same as in the first substrate, which is described later. The first conductive layer 204 is aligned with the second conductive layer 304, and the second conductive layer 304 is facing the internal dielectric layer 402. By laminating the second substrate 300 to the internal dielectric layer 402, the first and second conductive layers 204 and 304 are adjacent to the internal dielectric layer 402 on two opposing surfaces thereof. The first conductive layer 204, the internal dielectric layer 402 and the second conductive layer 304 thus construct a capacitor.

Referring to FIGS. 4-11, the fabrication process of the first substrate is illustrated.

In FIG. 4, a substrate is provided. The substrate has at least a first insulation core layer 202 and a conductive line 205 located on the first insulation core layer 202. An interconnect 206 is then formed as shown in FIG. 5 to FIG. 8.

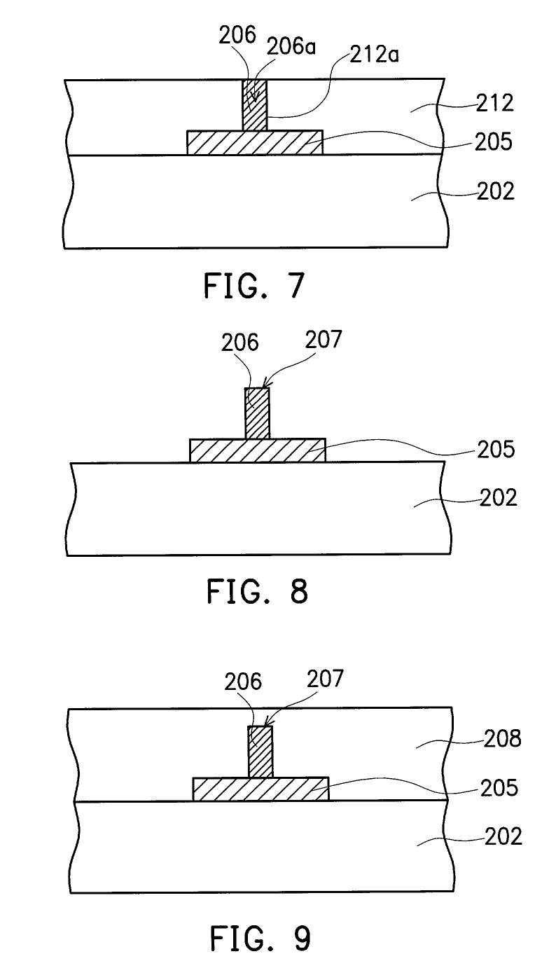

In FIG. 5, a photoresist layer 212 is formed over the substrate to cover the insulation core layer 202 and the conductive line 205. In FIG. 6, the photoresist layer 212 is patterned to form an opening 212a therein, so that a part of the conductive line 205 is exposed thereby. In FIG. 7, a conductive material 206a is formed to fill the opening 212a, so as to form an interconnect 206 that electrically connects the conductive layer 205. The interconnect has a top surface 207. The method for forming the conductive material 206a includes spray coating, spin coating, screen printing or cylinder press. However, the method for forming the conductive material 206a is not limited to the above processes. For example, an electroplating method (that is, a seed plating layer is formed on the photoresist layer 212 and the opening 212a globally, followed by a electroplating step to fill the conductive material) can also be applied here. In FIG. 8, the patterned photoresist layer 212 is removed.

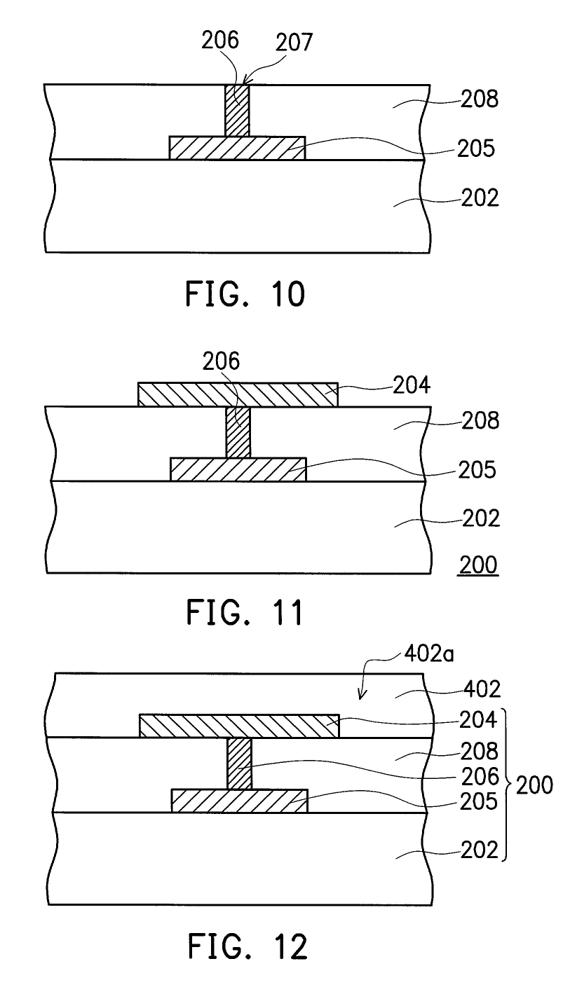

In FIG. 9 to FIG. 10, an insulation layer 208 is formed. In FIG. 9, the insulation layer 208 is formed to cover the interconnect 206, the conductive line 205 and the first insulation core layer 202. In FIG. 10, a part of the insulation layer 208 is removed, so that the remaining insulation layer 208 is level to the top surface 207 of the interconnect 206. The method to remove the insulation layer 208 includes a polishing process.

In FIG. 11, a first conductive layer 204 is formed to cover the insulation layer 208 and to electrically connect the interconnect 206, so as to form the first substrate 200.

The method for forming the second substrate 300 is similar to that for the first substrate 200. The process is not repeated here. The second substrate 300 has at least a second insulation core layer 302, a conductive line 305, an interconnect 306, an insulation layer 308, and a second conductive layer 304. The conductive line 305 is formed on the second insulation core layer 302. The interconnect 306 is electrically connected to the conductive line 305. The interconnect 306 has a top surface 307. The insulation layer 308 is formed to cover the interconnect 306, the conductive line 305 and the second insulation core layer 302, so that the insulation layer 308 is level to the top surface 307 of the interconnect 306. The second conductive layer 304 is formed to cover the insulation layer 308 and to electrically connect to the interconnect 306.

According to the invention, a coating process can be applied to the formation of the internal dielectric layer 402 on the first substrate 200, so that the thickness of the internal dielectric layer 402 can be easily controlled. Consequently, the device capacitance can be easily adjusted. Further, the conventional plate of dielectric material can be formed as the thinner internal dielectric layer 402. The second substrate is laminated into the internal dielectric layer with the conductive layer facing thereto, such that the conductive layers of the first and second substrates are adjacent to the internal dielectric layer on the opposing surfaces thereof.

Second Embodiment

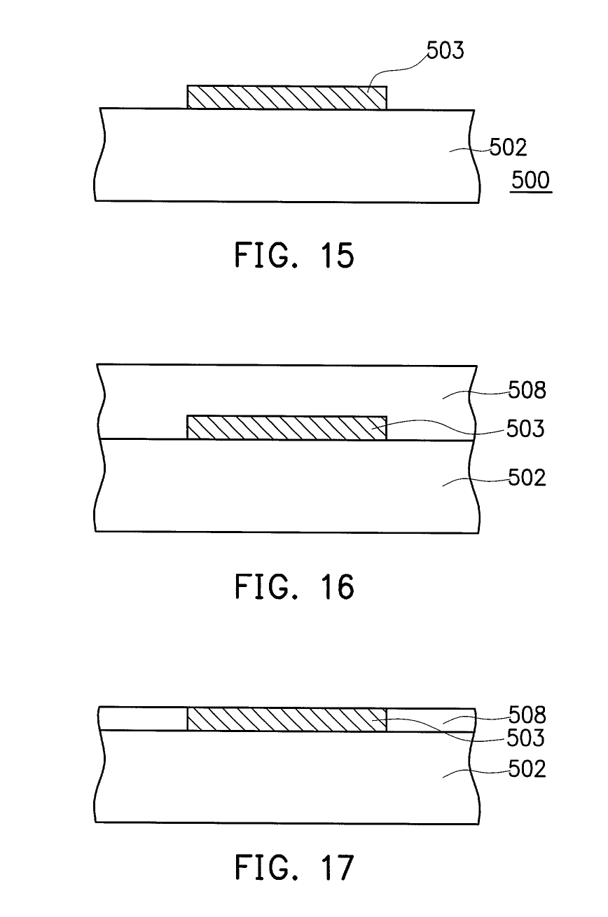

Referring to FIGS. 15 to 21, a second embodiment of the invention for forming a passive device on a printed circuit board is shown.

In FIG. 15, a substrate 500 has at least an insulation core layer 502 and a first conductive line 503 on the insulation core layer 502 is provided. Referring to FIGS. 16-17, an insulation layer 508 is formed.

In FIG. 16, an insulation layer 508 is formed to cover the first conductive line 503 and the insulation core layer 502. In FIG. 17, a part of the insulation layer 508 is removed to be level with the first conductive line 503. The method to remove a part of the insulation layer 508 includes a polishing process, for example.

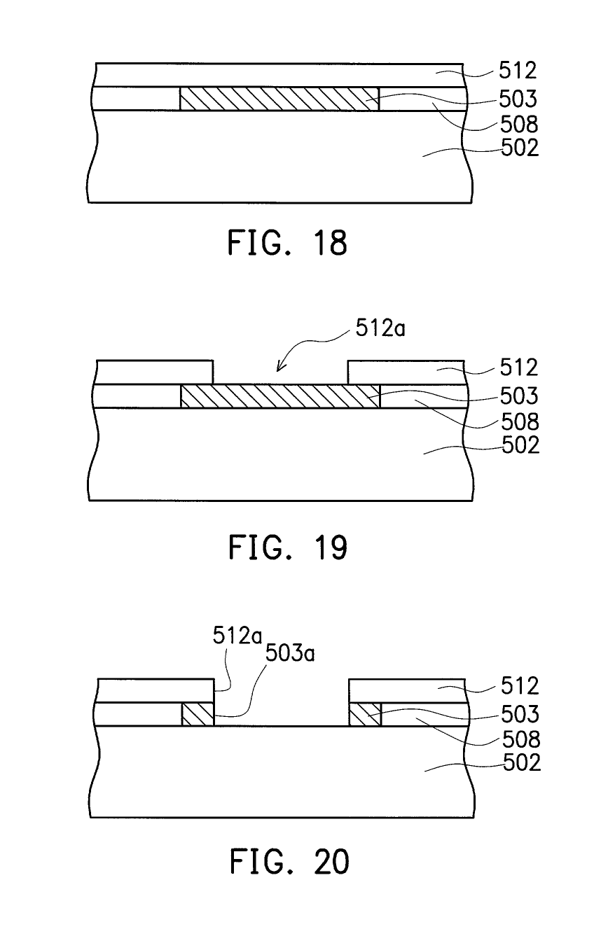

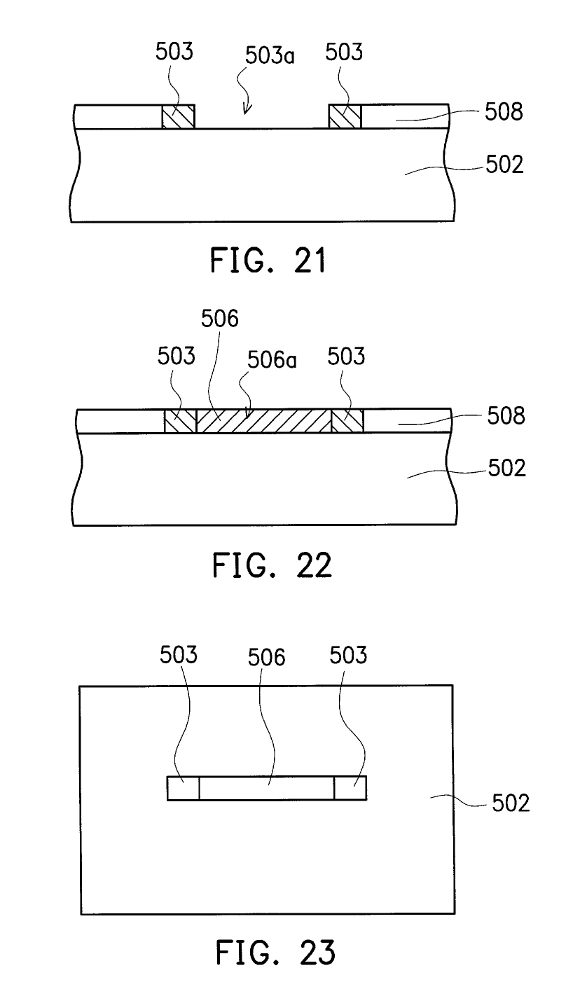

In FIGS. 18-21, a part of the first conductive line 503 is removed to form an opening 503a that divides the first conductive line 503 to make it an open circuit (as shown in FIG. 21). In FIG. 18, a photoresist layer 512 is formed on the first conductive line 503 and the insulation layer 508. In FIG. 19, the photoresist layer 512 is patterned to form an opening 512a therein. A part of the first conductive line 503 is exposed within the opening 512a. As shown in FIG. 20, the first conductive line 503 is divided at the opening 512a so that it becomes an open circuit. In FIG. 21, the photoresist layer 512 is removed.

In FIG. 22 and FIG. 23, which shows the top view of FIG. 22, a conductive material 506a is coated to fill the opening 503a, so that a second conductive line 506 is formed. Via the second conductive line 506, the first conductive line 503 becomes conducted again. The conductive material 506a has a conductivity different from that of the first conductive line 503. The method for coating the conductive material 506a includes spray coating, spin coating, screen printing and cylinder press. In this embodiment, the coating method is not limited to the above methods only. For example, the electroplating process (including performing an electroplating process to fill the conductive material 506a after forming a photoresist layer on a seed plating layer on the insulation layer 508, the first conductive line 503 and the opening 503a first) can also be applied. By the difference in conductivity between the first conductive line 503 and the second conductive line 506, an electron freeze-out occurs to form a resistor.

The invention uses a coating process to form a second conductive line 506 directly in the opening that is formed in the first conductive line 503, so that the passive device (the resistor) is formed without increasing the overall thickness of the substrate.

Accordingly, the coating process allows the first conductive line 503 and the second conductive line 506 to be formed as a same layer. Consequently, the resistance of the passive device can be precisely calculated from the exact effective area and length thereof.

Again, the conventional method for forming a resistor (referring to FIG. 3) results in an overlapped portion between the first and second conductive lines 106 and 103. The exact effective area and length of the resistor is difficult to obtain. Therefore, the invention provides a method to obtain a stable resistor resistance.

The method for forming a passive device on a printed circuit board provided by the invention includes the following advantages.

(1) In the invention, various capacitances can be obtained, so that the design flexibility for the printed circuit board is increased.

(2) The passive device (resistor) can be formed without increasing the overall thickness of the printed circuit.

(3) The resistance of the passive device on the printed circuit board can be precisely calculated.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. A method of fabricating a passive device on a printed circuit board, comprising:
providing a first substrate that comprises at least a first insulation core layer and a first conductive layer over the first insulation core layer;
providing a second substrate that comprises at least a second insulation core layer and a second conductive layer over the second insulation core layer;
coating a dielectric material over the first substrate to cover the first conductive layer to form an internal dielectric layer; and
laminating the second substrate with the first substrate, with the first conductive layer and the second conductive layer sandwiching and adjacent to the internal dielectric layer.

2. The method according to claim 1, wherein the method for coating the dielectric material includes spray coating, spin coating, screen printing or cylinder press.

3. The method according to claim 1, wherein the step for forming the first substrate further comprises:
providing a substrate, on which a first insulation core layer and a conductive line on the first insulation core layer are formed;
forming an interconnect to electrically connect the conductive line, wherein the interconnect has a top surface;
forming an insulation layer to cover the conductive line and the first insulation core layer, so that the insulation layer is level to the top surface of the interconnect; and
forming the first conductive layer to cover the insulation layer and to electrically connect the interconnect.

4. The method according to claim 1, wherein the step of forming the interconnect further comprises:
forming a patterned photoresist layer on the first insulation core layer and the conductive line, wherein the patterned photoresist layer has an opening exposing a part of the conductive line;
filling a conductive material in the opening to electrically connect the conductive line and
removing the patterned photoresist layer.

5. The method according to claim 4, wherein the step of filling the conductive material includes spray coating, spin coating, screen printing, cylinder press or electroplating.

6. The method according to claim 3, wherein the step of forming the insulation layer includes:
forming an insulation layer to cover the interconnect, the conductive layer and the first insulation core layer; and
removing a part of the insulation layer until it is level to the top surface of the interconnect.

7. The method according to claim 6, wherein the step of removing a part of the insulation layer includes a polishing process.

8. The method according to claim 1, wherein the step for forming the second substrate includes:
providing a substrate, on which the second insulation core layer and a conductive line on the second insulation core layer are formed;
forming an interconnect to electrically connect the conductive line, wherein the interconnect has a top surface;
forming an insulation layer to cover the conductive line and the second insulation core layer, so that the insulation layer is level to the top surface of the interconnect; and
forming the second conductive layer to cover the insulation layer and to electrically connect the interconnect.

9. The method according to claim 8, wherein the step of forming the interconnect further comprises:
forming a patterned photoresist layer on the second insulation core layer and the conductive line, wherein the patterned photoresist layer has an opening exposing a part of the conductive line;
filling a conductive material in the opening to electrically connect the conductive line and
removing the patterned photoresist layer.

10. The method according to claim 9, wherein the step of filling the conductive material includes spray coating, spin coating, screen printing, cylinder press or electroplating.

11. The method according to claim 8, wherein the step of forming the insulation layer includes:
forming an insulation layer to cover the interconnect, the conductive line and the second insulation core layer; and
removing a part of the insulation layer until it is level to the top surface of the interconnect.

12. The method according to claim 11, wherein the step of removing a part of the insulation layer includes a polishing step.

13. A method of fabricating a passive device on a printed circuit board, comprising:
providing a substrate, on which a first insulation core layer and a first conductive line on the insulation core layer are formed;
forming an insulation layer to cover the insulation core layer, wherein the insulation layer is level to the first conductive line;
removing a part of the first conductive line, dividing the first conductive line to make it an open circuit; and
coating a conductive material to fill the opening as a conductive line, so that the first conductive line becomes conducted thereby, wherein the conductive material has a conductivity different from that of the first conductive line.

14. The method according to claim 13, wherein the step of removing a part of the first conductive line further comprises:
forming a patterned photoresist layer on the insulation core layer and the first conductive line, wherein the patterned photoresist layer has an opening exposing a part of the first conductive line;
removing the exposed part of the first conductive line; and
removing the patterned photoresist layer.

15. The method according to claim 13, wherein the step of coating the conductive material includes spray coating, spin coating, screen printing, cylinder press or electroplating.

16. The method according to claim 13, wherein the step of forming the insulation layer includes:
forming an insulation layer to cover the first conductive line and the insulation core layer; and
removing a part of the insulation layer until it is level to the top surface of the first conductive line.

17. The method according to claim 16, wherein the step of removing a part of the insulation layer includes a polishing process.
